(19) United States
(12) Patent Application Publication
(10) Pub. No.: US 2014/0283021 A1
(43) Pub. Date: Sep. 18, 2014

(54) User Identification System for Parental and Security Controls

(71) Applicant: Beam Technologies, LLC, Louisville, KY (US)

(72) Inventors: Alexander D. Curry, Louisville, KY (US); Daniel E. Dykes, Louisville, KY (US)

(73) Assignee: Beam Technologies, LLC, Louisville, KY (US)

(21) Appl. No.: 14/213,885

(22) Filed: Mar. 14, 2014

Related U.S. Application Data
(60) Provisional application No. 61/783,865, filed on Mar. 14, 2013.

(51) Int. Cl. G06F 21/36

(52) U.S. Cl. CPC G06F 21/36
USPC 726/19

(57) ABSTRACT

A user identification system is provided for better parental and security controls on devices that require a user touch them for proper use. The user identification system comprises a base unit, a mobile unit, and the human body that provides signal transmission through capacitive coupling. A signal is sent from the base unit when it is contacted by a user, and the mobile unit sends a response signal containing the user identification. One embodiment of the mobile unit is a data transfer medium (i.e. “smartphone”). Embodiments of the base unit include a media device remote control and a computer input device.

### CROSS-REFERENCE TO RELATED APPLICATIONS

This application claims priority to U.S. Provisional Application No. 61/783,865 filed on Mar. 14, 2013.

### BACKGROUND OF THE INVENTION

This invention relates to user identification for parental and security controls on a number of devices. In particular, the invention relates to user identification for parental and security controls utilizing capacitive coupling.

Parental and security controls are used in various systems to authenticate identities of users and provide corresponding access to information. Largely, the function of parental and security controls in many devices, including computers and television, has been performed by passwords. Passwords can be easily bypassed and do not truly authenticate the identity of the user. Current methods lack the proper amount of authentication to identify specific users.

### BRIEF SUMMARY OF THE INVENTION

The invention aims to provide a user identification system for parental and security controls. The user identification system utilizes capacitive coupling to transfer signals from a base unit to a mobile unit and vice versa. The base unit and the mobile unit communicate using the human body as a capacitive coupler such that signals are transmitted at different frequencies through the human body's capacitance.

Some embodiments of the base unit include a media device remote control and a computer input device. One embodiment of the mobile unit is a data transfer medium.

Accordingly several advantages are to provide a user identification system that utilizes capacitive coupling, to provide a parental control system, to provide a security control system, and to provide a user identification system for information accessing devices. Still further advantages will become apparent from a study of the following descriptions and the accompanying drawings.

### BRIEF DESCRIPTION OF DRAWINGS

FIG. 1 is a schematic view of a user identification system utilizing capacitive coupling of the human body as described in multiple embodiments and alternatives.

### DETAILED DESCRIPTION OF THE INVENTION

The user identification system for parental and security controls is encompassed in a plurality of embodiments that shall be discussed in the present section.

A plurality of embodiments comprise a user identification system for parental and security controls. Current parental and security controls of devices are passive systems such that a password or key-like device is used to grant access to the protected device. Therefore, current parental and security controls afford the opportunity for unintended users to access the protected device. Accordingly, the proposed user identification system of the current invention provides an active system for parental and security controls such that the intended user must physically touch the device for access to be granted.

The user identification system comprises at least one base unit, at least one mobile unit, and the human body. The base unit and the mobile unit transmit signals at specified frequencies to one another using the human body as a capacitive coupler. The human body's capacitance allows it to transmit signals at different frequencies simultaneously as a capacitive coupler. The base unit comprises a data processing unit that constantly monitors for a touch input. When a touch input is detected by the base unit, it transmits a signal at a certain frequency to the mobile unit. The mobile unit also comprises a data processing unit. The mobile unit receives the signal from the base unit indicating the user is in contact with the base unit and transmits a response signal at a different frequency than the signal sent from the base unit. The response signal identifies the mobile unit using a unique identification code, thus identifying authorized users. Since the frequencies of the two signals differ, the signals can be sent simultaneously allowing for simultaneous identification of the user.

Optionally, a base unit can be configured to recognize multiple mobile units as authorized users. Additionally, a mobile unit can be configured to provide user identification to multiple base units such that the user only carries one mobile unit to access multiple devices.

A data processing unit comprises at least one collector, a storage medium, and at least one processor, wherein the collector, storage medium, and processor, respectively, collect, store, and process data. Accordingly, the data processing unit is chosen from the group microprocessor, microcontroller, field programmable gate array (FPGA), digital signal processing unit (DSP), application specific integrated circuit (ASIC), programmable logic, and combinations thereof.

Additionally, in some embodiments, the collector of the data processing unit is an electrically conductive wire, wherein the electrically conductive wire receives the electrical output of various sensors.

Moreover, the storage medium of the data processing unit is comprised of volatile memory and non-volatile memory, wherein volatile memory is used for short-term storage and processing, and non-volatile memory is used for long-term storage. Accordingly, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

The processor of the data processing unit is chosen from the group microprocessor and micro controller.

Optionally, the mobile unit is a data transfer medium, such as a “smartphone.” This configuration allows the user to identify himself to the base unit via a device the user is likely currently using. The data transfer medium comprises a receiver, a transmitter, a data processing unit, and a display. Accordingly, the data processing unit is chosen from the group microprocessor, microcontroller, field programmable gate array (FPGA), digital signal processing unit (DSP), application specific integrated circuit (ASIC), programmable logic, and combinations thereof. The data processing unit comprises a collector, storage medium, and a processor.

Moreover, the storage medium of the data processing unit is comprised of volatile memory and non-volatile memory, wherein volatile memory is used for short-term storage and processing, and non-volatile memory is used for long-term storage. Accordingly, in some embodiments, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Optionally, in some embodiments, non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

Further still, the processor of the data processing unit is chosen from the group microprocessor and microcontroller.

Additionally, the receiver of the data transfer medium is chosen from the group universal serial bus (USB), serial port, wired Ethernet port, radio frequency, microwave communication, infrared short-range communication, near field communication, and Bluetooth.

Optionally, the data transfer medium is chosen from the group personal computer, tablet computer, mobile phone (i.e. “smartphone”), television, dedicated system, charging station, network router, and web-enabled server.

Optionally, the transmitter of the data transfer medium is chosen from the group universal serial bus (USB), serial port, wired Ethernet port, radio frequency, microwave communication, infrared short-range communication, near field communication, and Bluetooth.

Additionally, the display of the data transfer medium converts signals into user-readable formats.

Optionally, the mobile unit is a dedicated system that is used for the sole purpose of transmitting the responding signal to the base unit, thus identifying the user. The dedicated system comprises a data processing unit that receives the signal from the base unit and transmits the user identification signal back to the base unit. The dedicated system is appropriately sized to be carried by the user for extended periods of time.

Optionally, the mobile unit is an activity tracker that is worn on the user's body for the purpose of collecting and tracking data related to the user's activity. An activity tracker provides the advantage of comprising a data processing unit and being worn by the user for at least a majority of the day. Therefore, the base unit transmits a signal to the activity tracker, and the activity tracker transmits a signal back to the base unit identifying the user.

Optionally, the mobile unit is a wrist-worn device such as a watch, bracelet, activity tracker, or any combination thereof. The wrist-worn device comprises a data processing unit that receives the signal from the base unit and transmits the user identification signal back to the base unit. The wrist-worn device provides the advantage of being able to be worn for extended periods of time without causing user fatigue.

Optionally, the mobile unit is an embedded chip in the user's body such that the user can consistently be identified by the base unit. Accordingly, the embedded chip comprises a data processing unit that receives the signal from the base unit and transmits a signal back to the base unit that identifies the user. Further, the embedded chip is manufactured from biocompatible materials such that it can be embedded in the body for an extended period of time.

Optionally, the mobile unit is a tattooed circuit on the user's skin such that the circuit can receive the signal from the base unit and transmit the user identification signal to the base unit. The tattooed circuit is a flexible circuit that is able to remain intact with the deformation of skin. Optionally, the tattooed circuit provides a means to easily attach and detach an external unit that may power the circuit or provide a data processing unit.

Optionally, the base unit is a remote control that controls a media device such as a television, cable/satellite box, media player, streaming box, and any combination thereof. Accordingly, the mobile unit identifies the user to the remote control through capacitive coupling of the human body. Additionally, the remote control may be configured to allow a master user to define what content can be accessed on the media device. Therefore, an enhanced parental control is created such that certain content can only be accessed when the user is identified as a user that is authorized to access said content. Optionally, the remote control may transmit the user identification to the media device, wherein the parental control system is comprised in the media device. Furthermore, the user identification code may be paired with the user input and said input must have an authorized user identification to access the content on the media device.

Optionally, the base unit is a computer input device that allows a user to input commands to a computer. Computer input devices include a keyboard, a computer mouse, a touch pad, and a touchscreen. Accordingly, the computer input device senses a user has made contact and transmits a signal to the mobile unit, and the mobile unit transmits a response signal with the user identification. Consequently, the computer input device can be configured to allow access to the computer to only authorized users of said computer. Further, content access can be defined by the user identification transmitted to the computer input device.

Optionally, the base unit is a tablet or smartphone comprising a touchscreen, collectively known as a touchscreen device. Accordingly, the touchscreen device monitors the touchscreen for user contact. When the touchscreen is contacted by a user, the touchscreen device transmits a signal to the mobile unit and receives the user identification signal from the mobile unit. Consequently, access to the touchscreen device is only granted to authorized users of the said touchscreen device such that the screen remains locked unless an authorized user contacts the touchscreen. Further, the user identification from the mobile unit can be used to define content access for certain users on a certain touchscreen device.

Optionally, the base unit is a camera that captures media and stores said media on a storage medium. When the camera is contacted by a user, the camera transmits a signal to the mobile unit and receives a user identification signal from the mobile unit, thus identifying the user of the camera. Consequently, access to stored media, settings, and functions of the camera is granted to only authorized users of the camera.

Optionally, the base unit is a garage door opener that opens garage doors with a signal unique to the garage door. Accordingly, a user contacts the garage door opener and a signal is transmitted to the mobile unit. The mobile unit transmits a response signal containing the user identification. Optionally, the garage door opener only transmits the signal unique to the garage door if the user identification is an authorized user of said garage door opener. In a further option, the user identification signal is coupled with the signal unique to the garage door such that the garage door does not operate unless both signals are authorized for said garage door. Lastly, the user identification signal is the signal unique to the garage door such that an authorized user identification operates the garage door.

Optionally, the base unit is a safe that stores items and often protects them from adverse conditions. Accordingly, the safe detects contact from a user and transmits a signal to the mobile unit. Consequently, the mobile unit transmits a response signal with user identification. The safe only allows access to authorized user identifications.

It will be understood that the embodiments described herein are not limited in their application to the details of the teachings and descriptions set forth, or as illustrated in the accompanying figures. Rather, it will be understood that a user identification system for parental and security controls, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “i.e.,” “containing,” or “having,” and variations of those words is meant to encompass the items listed thereafter, and equivalents of those, as well as additional items.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A user identification system, comprising:
at least one base unit having a data processing unit that is configured to store and process data and detect touch input from the user; and
at least one mobile unit having a data processing unit that is configured to store and process data and communicate with the base unit via capacitive coupling,
wherein both the base unit and the mobile unit are in contact with human body such that the human body acts as a capacitive coupler and is arranged to allow for the transmission of at least one signal.

2. The user identification system of claim 1, wherein the base unit is configured to transmit a signal at a frequency that is different from the frequency of the signal that the mobile unit is configured to transmit.

3. The user identification system of claim 2, wherein the base unit and the mobile unit are configured to transmit signals simultaneously.

4. The user identification system of claim 1, wherein the base unit is configured to transmit a signal to the mobile unit when a touch input is detected.

5. The user identification system of claim 4, wherein the mobile unit is configured to transmit a response signal to the base unit.

6. The user identification system of claim 5, wherein the response signal further comprises at least one identification code.

7. The user identification system of claim 1, wherein the mobile unit is comprised in a data transfer medium additionally having a transceiver that is configured to transmit and receive data and a display.

8. The user identification system of claim 1, wherein the mobile unit is comprised in a dedicated system that is configured for the sole purpose of transmitting a responding signal to a base unit.

9. The user identification system of claim 1, wherein the mobile unit is comprised in an activity tracker that is configured to be worn on the human body for the purpose of collecting and tracking activity data of the user.

10. The user identification system of claim 1, wherein the mobile unit is comprised in a wrist-worn device.

11. The user identification system of claim 1, wherein the mobile unit is comprised in a chip that is configured to be embedded into the body of the user.

12. The user identification system of claim 1, wherein the mobile unit is comprised in a tattooed circuit that is configured to be substantially located on the skin of the user.

13. The user identification system of claim 1, wherein the base unit is configured to be a media device remote control.

14. The user identification system of claim 1, wherein the base unit is configured to be a computer input device that is configured to allow a user to input commands to a computer.

15. The user identification system of claim 1, wherein the base unit is configured to be a touchscreen device that is configured to monitor the touchscreen for user contact.

16. The user identification system of claim 1, wherein the base unit is configured to be a camera that is configured to capture media and store said media on a storage medium.

17. The user identification system of claim 1, wherein the base unit is configured to be a garage door opener.

18. The user identification system of claim 1, wherein the base unit is configured to be a safe that is configured to store items.

19. A user identification system, comprising:
a media device remote control that is configured to be a base unit having a data processing unit that is configured to store and process data and detect touch input from the user; and
at least one mobile unit having a data processing unit that is configured to store and process data and communicate with the base unit via capacitive coupling,
wherein both the media device remote and the mobile unit are in contact with human body such that the human body acts as a capacitive coupler and is arranged to allow for the transmission of at least one signal.

20. A user identification system, comprising:
a computer input device that is configured to be a base unit having a data processing unit that is configured to store and process data and detect touch input from the user; and
at least one mobile unit having a data processing unit that is configured to store and process data and communicate with the base unit via capacitive coupling,
wherein both the computer input device and the mobile unit are in contact with human body such that the human body acts as a capacitive coupler and is arranged to allow for the transmission of at least one signal.
